(19) United States
(12) Patent Application Publication
(10) Pub. No.: US 2011/0289446 A1
(43) Pub. Date: Nov. 24, 2011

(54) INFORMATION PROCESSING APPARATUS, INFORMATION PROCESSING METHOD, AND PROGRAM THEREFOR

(75) Inventors: Koji Fukui, Chiba (JP); Kensuke Oonuma, Tokyo (JP)

(73) Assignee: Sony Corporation, Tokyo (JP)

(21) Appl. No.: 13/103,411

(22) Filed: May 9, 2011

(30) Foreign Application Priority Data
May 18, 2010 (JP) P2010-114069

(51) Int. Cl. G06F 3/048

(52) U.S. Cl. 715/776

(57) ABSTRACT

Provided is an information processing apparatus including an acquisition unit, a reproduction unit, an input unit, and a control unit. The acquisition unit obtains, of moving image data including images of pages having serial page numbers and an image of motion of turning the pages one by one in order of the page numbers, first moving image data in which a page time being a time on the moving image data is assigned to each page. The reproduction unit reproduces the first moving image data, generates a moving image, and displays the moving image on a display screen. The input unit receives a designation of a second page different from a first page of the first moving image data currently displayed on the display screen. The control unit calculates a page time difference therebetween and controls a reproduction speed of the first moving image data depending on it.

### CROSS-REFERENCE TO RELATED APPLICATION

The present application claims priority from Japanese Patent Application No. JP 2010-114069 filed in the Japanese Patent Office on May 18, 2010, the entire content of which is incorporated herein by reference.

### BACKGROUND OF THE INVENTION

1. Field of the Invention

The present invention relates to an information processing apparatus, an information processing method, and a program therefor, for referring to book contents.

2. Description of the Related Art

In recent years, with the spread of electronic books and the like, there are more and more opportunities to refer to “book contents” being contents including images of a plurality of pages on a display. A referring device enabling the above-mentioned reference to the book contents allows a user to refer to the electronic book in such a manner that an image of a page (hereinafter, referred to as page image) is sequentially switched to another page image and is displayed according to an input operation of page turning by the user.

In the above-mentioned referring device, there has been a referring device for displaying a video for giving the user feeling as if the user turns pages in reality when one page image is switched to another page image. For example, Japanese Patent Application Laid-open No. HEI 7-319899 (paragraph [0032], FIG. 2) (hereinafter, referred to as Patent Document 1) discloses a “page turning display control apparatus” capable of displaying a video of page turning. This apparatus sets a page turning speed and an angle between pages based on a page turning speed that the user wants, and generates and displays a video in which a page is turned based on the above-mentioned information and the page images displayed before and after page turning.

### SUMMARY OF THE INVENTION

However, in the page turning display control apparatus disclosed in Patent Document 1, after received a request from the user, a video of page turning is generated based on the page images displayed before and after page turning, and hence, for example, in a device such as a portable information terminal having a limited image processing capacity, it may be difficult to display a smooth motion of page turning.

On the other hand, also conceivable is a method of realizing a page-turning video by reproducing a moving image. In this case, in comparison with a method of generating the page-turning video based on the page images each time, it is possible to reduce entire load on an arithmetic processing apparatus. Further, even in a device having a relatively low arithmetic processing capability, a possibility of displaying a smooth motion of page turning is increased. In the case where the motion of page turning is displayed by use of the moving image as described above, in such a manner that a difference between a designated page as a final destination of turning and a current page is reflected on a period of time of page turning operation, it is possible to give the user a realization of a movement amount of pages. However, as the total page number of the electronic book is increased, the maximum number of pages turned together with page turning motions is also increased. Therefore, a period of time of the page turning motion set to correspond to the page movement amount, which given to the user as a realization, may be too long with a result that the user feels uncomfortable.

In view of the above-mentioned circumstances, there is a need for providing an information processing apparatus, an information processing method, and a program therefor, which are capable of displaying a smooth motion of page turning and realizing an optimization of time of the page turning motion, to thereby increase operability for the user.

According to an embodiment of the present invention, there is provided an information processing apparatus including an acquisition unit, a reproduction unit, an input unit, and a control unit.

The acquisition unit obtains, of moving image data including images of a plurality of pages having serial page numbers and an image of motion of turning the plurality of pages one by one in order of the page numbers, first moving image data in which a page time being a time on the moving image data is assigned to each of the plurality of pages.

The reproduction unit reproduces the first moving image data obtained by the acquisition unit, generates the moving image, and displays the moving image on a display screen.

The input unit receives, from a user, a designation of a second page different from a first page, the first page being a page of the first moving image data currently displayed on the display screen.

The control unit calculates a page time difference being a difference between a page time of the first page and a page time of the second page, and controls the reproduction speed of the first moving image depending on the page time difference.

In the information processing apparatus according to the embodiment of the present invention, the reproduction speed of the moving image in which the pages are turned from the first page to the second page is controlled depending on the page time difference between the first page being displayed and the second page designated by the user, and hence it is possible to set a period of time of the motion of page turning to have a length suitable for the user. With this, the operability for the user is enhanced. Further, it is unnecessary to generate a video including the motion of page turning based on images of a plurality of pages, and hence the display of the motion of page turning is made less dependent on the processing capability of the information processing apparatus.

The control unit may select a first reproduction speed being a normal speed in a case where the page time difference is smaller than a predetermined first time difference. Further, the control unit may select a reproduction speed at which a period of time for reproducing the moving image corresponding to the page time difference is the closest to the first time difference in a case where the page time difference is equal to or larger than the first time difference.

The first time difference is a predetermined time difference, for example, a time difference arbitrarily defined as a period of time suitable for the user to view the page-turning video. In the case where the page time difference is smaller than the first time difference, through a reproduction of the moving image at the normal speed, the page turning from the first page to the second page is completed within a period of time corresponding to the first time difference. On the other hand, in the case where the page time difference is equal to or larger than the first time difference, the page turning from the first page to the second page within a period of time corresponding to the first time difference is not completed though a reproduction of the moving image at the normal speed. In view of this, in the case where the page time difference is equal to or larger than the first time difference, the control unit switches the reproduction speed so that a period of time necessary for reproducing the moving image corresponding to the page time difference becomes closer to that in the case of the first time difference. With this, the information processing apparatus according to the embodiment of the present invention is capable of completing the movement from the first page to the second page substantially within a predetermined period of time even if the page time difference is large.

The control unit may jump the reproduction time of the first moving image data in a case where the page time difference is equal to or larger than a second time difference, the second time difference being set in advance within a range larger than the first time difference.

With this, in the case where the page time difference is large, instead of displaying the page-turning video for a long time, it is possible to jump, at a time, the reproduction time for displaying in the moving image data.

The control unit may vary the second reproduction speed depending on the reproduction time.

The information processing apparatus according to the embodiment of the present invention is, for example, capable of gradually increasing the second speed when the page movement is started, and gradually reducing the second speed when the reproduction time becomes close to that of the second page. With this, it is possible to realize a more realistic page-turning video.

The acquisition unit may further obtain second moving image data constituted of an image of motion of turning the plurality of pages one by one in order of the page numbers, and the control unit may cause the reproduction unit to reproduce the second moving image data in a case where the page time difference is equal to or larger than a second time difference, the second time difference being set in advance within a range larger than the first time difference.

The information processing apparatus according to the embodiment of the present invention is capable of reproducing the second moving image data in which the pages are turned at higher speed instead of the first moving image data in which the pages are turned one by one in the case where the page time difference is large, to thereby cause the user to view the page-turning video in which the pages are turned at high speed.

The acquisition unit may further obtain third moving image data including a motion of turning the plurality of pages one by one in reverse order of the page numbers, and the control unit may cause the reproduction unit to reproduce the third moving image data in a case where the page number of the second page is smaller than the page number of the first page.

In the page number of the second page is smaller than the first page number in the first moving image data, it is necessary to reversely reproduce the page-turning video from the first page to the second page. However, with an apparatus of a type including the reproduction unit incapable of performing a reverse reproduction, it may be impossible to display the page-turning video. However, the information processing apparatus according to the embodiment of the present invention is capable of reproducing, when the second page is designated, a part of the third moving image data, in which the page turning proceeds from the second page to the first page, to thereby reproduce the page-turning video even in this case.

According to another embodiment of the present invention, there is provided an information processing method including obtaining, by an acquisition unit, of moving image data including images of a plurality of pages having serial page numbers and an image of motion of turning the plurality of pages one by one in order of the page numbers, first moving image data in which a page time being a time on the moving image data is assigned to each of the plurality of pages.

The reproduction unit reproduces the first moving image data obtained by the acquisition unit, generates a moving image, and displays the moving image on a display screen.

The input unit receives, from a user, a designation of a second page different from a first page, the first page being a page of the first moving image data currently displayed on the display screen.

The control unit calculates a page time difference being a difference between a page time of the first page and a page time of the second page, and controls the reproduction speed of the first moving image data depending on the page time difference.

According to another embodiment of the present invention, there is provided a program including an acquisition unit, a reproduction unit, an input unit, and a control unit.

The acquisition unit obtains, of moving image data including images of a plurality of pages having serial page numbers and an image of motion of turning the plurality of pages one by one in order of the page numbers, first moving image data in which a page time being a time on the moving image data is assigned to each of the plurality of pages.

The reproduction unit reproduces the first moving image data obtained by the acquisition unit, generates a moving image, and displays the moving image on a display screen.

The input unit receives, from a user, a designation of a second page different from a first page, the first page being a page of the first moving image data currently displayed on the display screen.

The control unit calculates a page time difference being a difference between a page time of the first page and a page time of the second page, and controls the reproduction speed of the first moving image data depending on the page time difference.

As described above, according to the embodiments of the present invention, it is possible to provide an information processing apparatus, an information processing method, and a program therefor, which are capable of displaying a smooth motion of page turning and realizing an optimization of time of the page turning motion, to thereby increase operability for the user.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a block diagram showing a configuration of an information processing apparatus according to a first embodiment;

FIG. 2 is a view showing the content of a moving image displayed at a reproduction time when first moving image data is reproduced;

FIG. 3 is a schematic diagram showing a video, which is displayed when the first moving image data is reproduced, as a frame;

FIG. 4 is a view showing a page time table in the first embodiment;

FIG. 5 is a conceptual view showing a method of determining a reproduction speed;

FIG. 6 is a flow chart of a reproduction control by the information processing apparatus according to the first embodiment;

FIG. 7 is a conceptual view for describing a variable speed reproduction in a second embodiment;

FIG. 8 is a flow chart of a reproduction control by an information processing apparatus according to the second embodiment;

FIG. 9 is a view showing the content of a video displayed at a reproduction time when second moving image data is reproduced;

FIG. 10 is a schematic diagram showing a video, which is displayed when the second moving image data is reproduced, as a frame;

FIG. 11 is a view showing a page time table in the third embodiment;

FIG. 12 is a flow chart of a reproduction control by an information processing apparatus according to the third embodiment;

FIG. 13 is a flow chart of the reproduction control by the information processing apparatus according to the third embodiment;

FIG. 14 is a view showing the content of a video displayed at a reproduction time when third moving image data is reproduced;

FIG. 15 is a schematic diagram showing a video, which is displayed when the third moving image data is reproduced, as a frame;

FIG. 16 is a view showing a page time table in the fourth embodiment; and

FIG. 17 is a flow chart of a reproduction control by an information processing apparatus according to the fourth embodiment.

### DESCRIPTION OF PREFERRED EMBODIMENTS

Hereinafter, embodiments of the present invention will be described with reference to the drawings.

### First Embodiments

A first embodiment of the present invention will be described.

### [Configuration of Information Processing Apparatus]

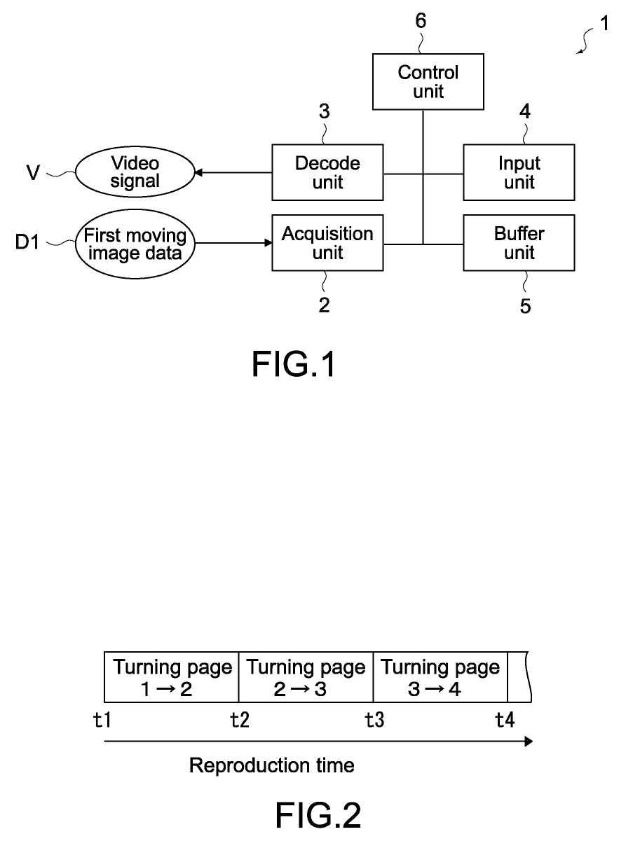

FIG. 1 is a block diagram showing a configuration of an information processing apparatus 1 according to a first embodiment of the present invention. As shown in FIG. 1, the information processing apparatus 1 includes an acquisition unit 2, a decode unit 3, an input unit 4, a buffer unit 5, and a control unit 6, which are connected to each other via a system bus.

The acquisition unit 2 obtains first moving image data D1, and transfers the first moving image data D1 to the buffer unit. The acquisition unit 2 may be, for example, a disk drive, and may obtain the first moving image data D1 recorded on a recording medium such as a digital versatile disc (DVD) or a Blu-ray Disc (registered mark) (BD). Further, the acquisition unit 2 may be, for example, a network such as the Internet, and may receive the first moving image data D1 transmitted from the outside via a transmission medium.

The decode unit 3 receives the first moving image data D1 from the buffer unit, and outputs the first moving image data D1 as decoded video signals V on a display included in the information processing apparatus 1 or an external display connected through an interface to the information processing apparatus 1. The decode unit 3 may be, for example, a processor for image processing, which receives and decodes, for example, the first moving image data D1 compression-encoded in a predetermined method such as MPEG-2. The decode unit 3 is capable of performing a switching of a reproduction speed and a change of a reproduction point (time on moving image data) under control by the control unit 6.

The input unit 4 enables an operation by a user, and transmits an input operation to the control unit 6. The input unit 4 may be, for example, a remote controller. The input unit 4 is one that at least enables a reception of the inputs of the designation of the page number by the user.

The buffer unit 5 is a storage area for temporarily storing the first moving image data D1 until the first moving image data D1 is decoded by the decode unit 3 after the first moving image data D1 is obtained by the acquisition unit 2.

The control unit 6 generally controls the information processing apparatus. The control unit 6 includes, more specifically, a central processing unit (CPU), a ROM, a RAM, and the like. The ROM stores a program and the like to be executed by the CPU. The RAM is a main memory to be used as a working area of the CPU.

It is sufficient that the information processing apparatus 1 have the above-mentioned configuration, and product form of the information processing apparatus 1 is not particularly limited. Specifically, the information processing apparatus 1 can be provided as a PC, an electronic book apparatus, a PDA, a disk player (BD player), a cellular phone, a television set, or the like.

### [Structure of First Moving Image Data]

The first moving image data D1 will be described. The first moving image data D1 is data of a book content including images of a plurality of pages (hereinafter, referred to as page images) sequentially displayed according to the operation by the user.

FIG. 2 is a view showing the content of a moving image displayed at a reproduction time when the first moving image data D1 is reproduced. As shown in the drawing, the first moving image data D1 is constituted of sequential page-turning videos from the page 1 to the last page. For example, a page-turning video from the page 1 to the page 2 is followed by a page-turning video from the page 2 to the page 3. A time on the moving image, which serves to divide the videos between the pages, is referred to as “the page time tN” when a page displayed at that time is referred to as a page N.

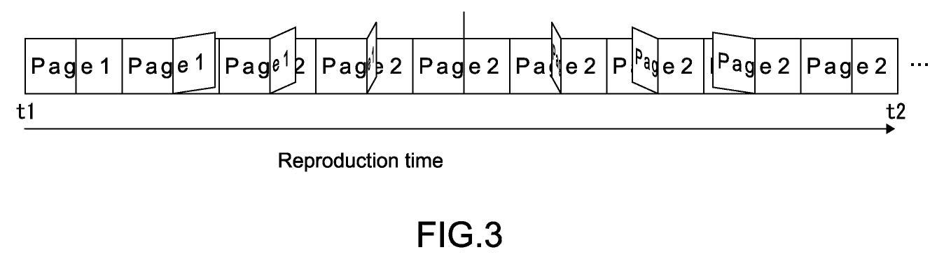

FIG. 3 is a schematic diagram showing a video, which is displayed when the first moving image data D1 is reproduced, as a frame. As shown in the drawing, from the page time t1 to the page time t2, the page-turning video from the page 1 to the page 2 is reproduced. Although in FIG. 3, the page-turning video is expressed in a discontinuous way, in fact, more frames are used so that the video can be made continuous. In this case, the page-turning video between the page 1 and the page 2 is displayed by using an image of the page 1 and an image of the page 2, and the page-turning video between the page 2 and the page 3 is displayed by using the image of the page 2 and an image of the page 3. In order to prevent the video from looking unnatural even when the video is reversely reproduced, the page-turning video is, for example, set to be a symmetrical video of the preceding image and the subsequent image at a middle time between the page time t1 and the page time t2. Further, the page-turning video is not limited to the video shown in FIG. 3. For example, the upper side of each of the page images may be set as a binding side of the book.

Although the details will be described later, when the user wants to refer to a specified page, the user uses the input unit 4 to designate the page number of the page that the user wants to refer to. Then, the reproduction is paused at the time of the designated page. In this manner, the user can refer to the content of that page.

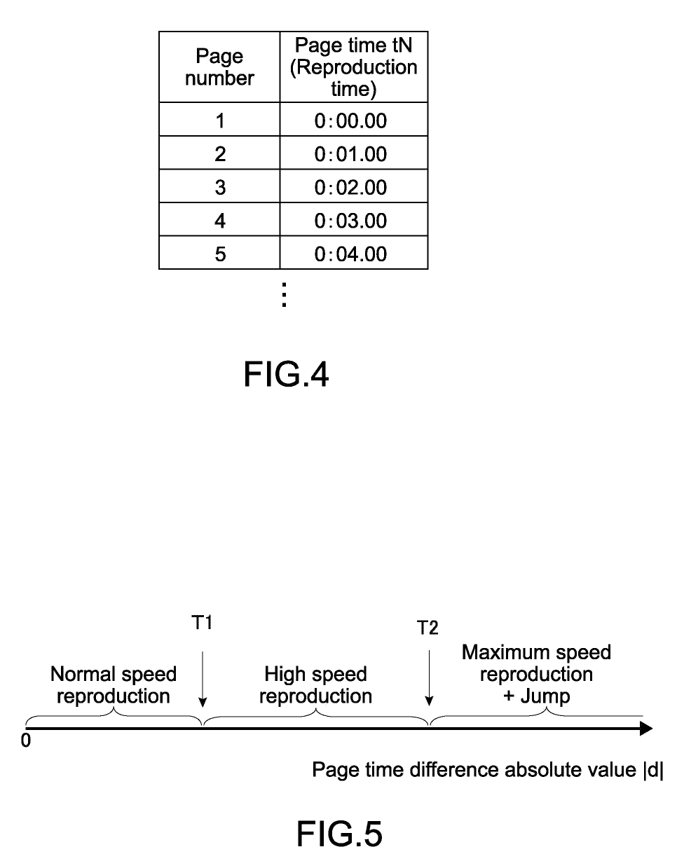

Further, the first moving image data D1 includes a “page time table.” FIG. 4 is a view showing an example of the page time table. As shown in the drawing, the page time table is a table in which a top reproduction time (page time tN) when each page becomes a lead page is registered. In the example shown in FIG. 4, the page 1 is the lead page, and hence the page time t1 of the page 1 is 0:00.00. Further, the video is set to have a predetermined time difference between two pages so that the pages can be turned one by one at predetermined time intervals. In the example of FIG. 4, the predetermined time difference is set to 1 second. It should be noted that the time difference between two pages may be varied.

### [Reproduction of Moving Image]

Next, the outline of the reproduction operation of the book content according to the information processing apparatus 1 of this embodiment.

First, the control unit 6 receives an instruction of reproducing the book content from the user, and then controls the acquisition unit 2 to obtain the first moving image data D1 recorded on the recording medium. The first moving image data D1 obtained by the acquisition unit 2 from the recording medium is supplied to the decode unit 3. In the case where the user does not designate the page to be reproduced, the control unit 6 gives an instruction to the decode unit 3 so as to start a reproduction from the lead page of the first moving image data D1. Thus, the lead page of the first moving image data D1 is displayed on the display, and the user can view the page image displayed on the display. In the case where the user designate, at the start time, the page that the user wants to refer to, the control unit 6 gives an instruction to the decode unit 3 so as to start a reproduction from the designated page. Thus, the page that the user wants to refer to is displayed on the display.

Here, when the user uses the input unit 4 to designate the page number of a page to be next displayed, the control unit 6 refers to the page time table and calculates a “page time difference” (hereinafter, referred to as page time difference d). The page time difference d is a difference between the page time of a currently displayed page (hereinafter, referred to as “source page”) and the page time of the page that the user has newly designated (hereinafter, referred to as “destination page”). It should be noted that, the destination page may be a page having the page number smaller than the page number of the source page. In the following, it is assumed that the source page is a page x (that is, the reproduction time is a page time tx), and the destination page is a page y (that is, the reproduction time is a destination page time ty).

In general, the control unit 6 uses the thus calculated absolute value |d| (hereinafter, referred to as “page time difference absolute value |d|”) to determine a reproduction speed of the first moving image data D1 of the decode unit 3. FIG. 5 is a conceptual view showing a method of determining the reproduction speed by the control unit 6. As shown in the drawing, in the case where the page time difference absolute value |d| is smaller than a first time difference T1, the control unit 6 controls the decode unit 3 to perform a normal speed reproduction. Further, in the case where the page time difference absolute value |d| is larger than the first time difference T1 and smaller than a second time difference T2, the control unit 6 controls the decode unit 3 to perform a high speed reproduction. In addition, in the case where the page time difference absolute value |d| is larger than the second time difference T2, the control unit 6 controls the decode unit 3 to perform a reproduction through combining a maximum speed reproduction with a jump.

The first time difference T1 is a period of time T defined in advance as one suitable for the user to view the page-turning video, and is arbitrarily set. In the case where the page time difference absolute value |d| is smaller than the first time difference T1, the movement from the source page to the destination page can be performed within a suitable period of time even if the video is reproduced at the normal reproduction speed (normal speed). Therefore, the reproduction speed is set to be the normal speed reproduction.

In the case where the page time difference absolute value |d| is larger than the first time difference T1, the movement from the source page to the destination page may not be performed within a period of time suitable for the user to view the page-turning video if the normal speed reproduction is performed. Therefore, the reproduction speed is set to be the high speed reproduction. The high speed reproduction means fast-forward or fast-rewind, and the reproduction speed of the high speed reproduction is set so that the time which it takes to move from the source page to the destination page becomes the closest to that in the case of the first time difference T1.

The second time difference T2 is a time difference obtained by multiplying a period of time M being a predetermined time difference larger than the first time difference T1 by a maximum reproduction speed N, and thus, is expressed by “N×M.” The period of time M is, more specifically, a period of time, for which the user can be probably waited without feeling uncomfortable, for example, 8 seconds. That is, the second time difference T2 is a reproduction time on the moving image, which proceeds at a maximum amount during the period of time M. In the case where the page time difference absolute value |d| is larger than the second time difference T2, the control unit 6 controls the decode unit 3 to perform a reproduction through combining a reproduction at the highest speed with a jump. With this, the moving image of the page turning is prevented from being monotonously displayed for a long time. The reproduction at the highest speed means a reproduction at the maximum speed, which depends on limit on a reading speed of data from the recording medium of the acquisition unit, a processing capacity of the decode unit 3, and the like. Typically, a speed in the case of reading and reproducing data in real time from the recording medium is referred to as a “normal speed,” and the reproduction speed N-times larger than the “normal speed” is referred to as the “N times speed.” In the typical reproduction apparatus, the reproduction speed is switched to “normal speed,” “double speed,” “quadruple speed,” “octuple speed,” and so on. In the following description, the operation of calculating an optimum reproduction speed is referred to. However, the reproduction speed calculated in that case is merely an ideal value, and thus, actually, the reproduction speed equal to the ideal value may not be obtained due to the limit on the reproduction speed which can be switched. However, for the sake of simplicity of the description, the description will be made assumed that the reproduction speed equal to the ideal value can be obtained. On the other hand, the jump means a movement of a reproduction point between pages away from each other.

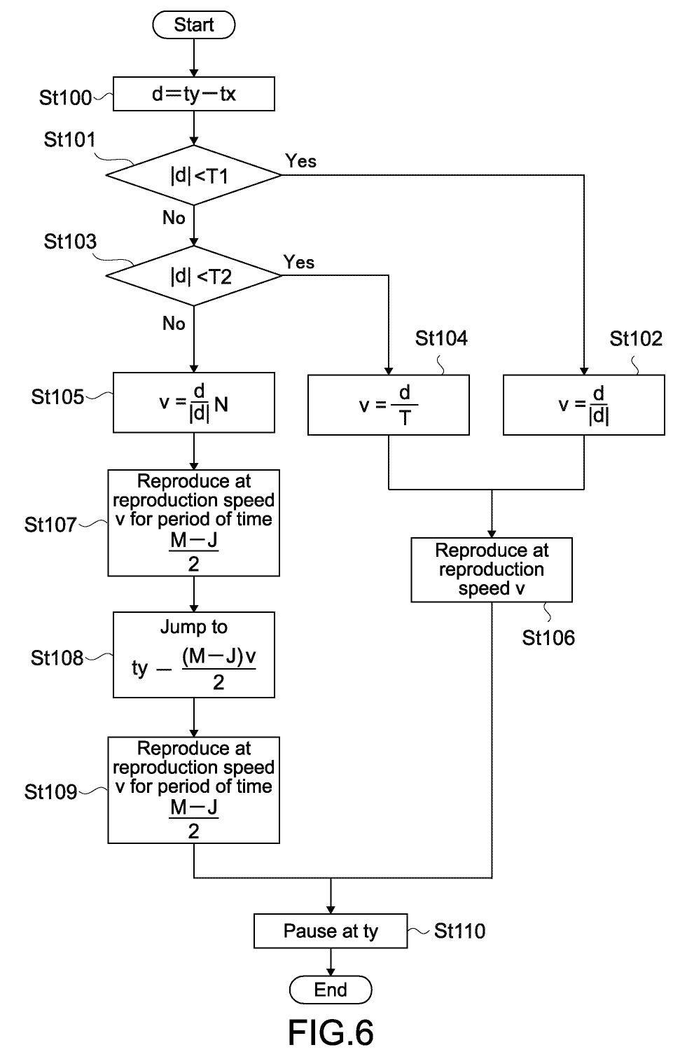

FIG. 6 is a flow chart of a control of the decode unit 3 by the control unit 6. As described above, the control unit 6 determines the page time difference d by subtracting the page time tx from the page time ty (St100). Next, the control unit 6 compares the page time difference absolute value |d| with the first time difference T1 (St101). In the case where the page time difference absolute value |d| is smaller than the first time difference T1 (Yes in St101), the control unit 6 sets the reproduction speed v to d/|d|. That is, the reproduction speed corresponding to the normal speed reproduction is set (St102). In the case where the page time difference absolute value |d| is larger than the first time difference T1 (No in St101), the control unit 6 compares the page time difference absolute value |d| with the second time difference T2 (St103).

Next, in St103, in the case where the page time difference absolute value |d| is smaller than the second time difference T2 (Yes in St103), the control unit 6 sets the reproduction speed v to d/T. That is, the reproduction speed corresponding to the high speed reproduction is set (St104). The reproduction speed means a reproduction speed to moves by the page time difference d during a period of time T defined in advance as one suitable for the user to view the page-turning video. Thus, when the above-mentioned reproduction speed is set, the setting is performed in the following manner. Specifically, as the difference between the page time tx and the page time ty becomes larger, the reproduction speed v set to become higher so that the movement is completed for a period of time closer to the first time difference T1 as much as possible. It should be noted that, in the case where d/T does not correspond to the reproduction speed that the decode unit 3 can employ, d/T (ideal value) is set as the reproduction speed.

In the case where the page time difference absolute value |d| is larger than the second time difference T2 (No in St103), the reproduction speed v is set to (d/|d|)·N. That is, the reproduction speed corresponding to the maximum speed reproduction is set (St105). The N is the maximum reproduction speed of the decode unit 3 as described above. As described above, the control unit 6 determines the reproduction speed depending on the page time difference absolute value |d| in St101 or St103.

Next, in the case of “Yes” in St101 or St103, the control unit 6 controls the decode unit 3 to reproduce the first moving image data D1 at the reproduction speed v determined in St102 or St104 (St106).

Further, in the case of “No” in St103, the control unit 6 controls the decode unit 3 to reproduce the first moving image data D1 for a period of time of (M−J)/2 at the reproduction speed v determined in St105 (St107). The M is a period of time for which the user can wait as described above, and the J is a period of time necessary for performing the jump. In order to perform the reproduction at the maximum reproduction speed immediately before the start of the movement and immediately after the end of the movement, the control unit 6 controls the decode unit 3 to reproduce the first moving image data D1 for a period of time of a half of M−J at the maximum reproduction speed.

Subsequently, the control unit 6 controls the decode unit 3 to cause the reproduction time of the first moving image data D1 to jump to the reproduction time of ty−(M−J)·v/2 (St108). The ty−(M−J)·v/2 being the reproduction time means such a reproduction time that a remained period of time up to the page time ty becomes (M−J)·v/2 during which the maximum speed reproduction is performed immediately before the end of the movement. Subsequently, the control unit 6 controls the decode unit 3 to reproduce the first moving image data D1 for a period of time of (M−J)/2 at the reproduction speed v again from the reproduction time of ty−(M−J)·v/2 (St109).

The control unit 6 controls the decode unit 3 to pause the reproduction of the first moving image data D1 when the reproduction time arrives at the page time ty in the reproduction in St106 or St109 (St110). With this, the image of the destination page at the page time ty is displayed on the display. The control unit 6 determines the reproduction speed depending on the page time difference between the source page and the destination page, and hence even if the difference between the source page and the destination page is large, the movement can be completed within a predetermined period of time while displaying the appropriate page-turning video.

As described above, in this embodiment, the information processing apparatus 1 controls, depending on the page time difference between the source page and the destination page, the reproduction speed of the first moving image data D1 constituted of the page-turning videos. With this, the information processing apparatus 1 is capable of displaying the page-turning videos within an appropriate period of time not too long through the designation of the destination page by the user. With this, the operability for the user is enhanced. Further, the first moving image data D1 is constituted of the page-turning videos generated in advance, and hence it is unnecessary for the information processing apparatus 1 to generate based on the page images the page-turning video each time. Therefore, the information processing apparatus 1 is capable of displaying the page-turning videos even if the control unit 6, the decode unit 3, or the like has a low information processing capacity.

### Second Embodiment

A second embodiment of the present invention will be described.

In the second embodiment, the same parts as those in the first embodiment will be denoted by the same symbols and the description thereof will be omitted.

### [Reproduction of Moving Image]

The control unit 6 uses the page time difference absolute value |d| calculated as in the first embodiment to determine the reproduction speed of the first moving image data D1 of the decode unit 3. Similarly, in the case where the page time difference absolute value |d| is smaller than the first time difference T1, the control unit 6 controls the decode unit 3 to perform the normal speed reproduction. Further, in the case where the page time difference absolute value |d| is larger than the first time difference T1 and smaller than the second time difference T2, the control unit 6 controls the decode unit 3 to perform a variable speed reproduction. In the case where the page time difference absolute value |d| is larger than the “second time difference” T2, the control unit 6 controls the decode unit 3 to perform a reproduction through combining the variable speed reproduction with the jump.

The first time difference T1 in this embodiment is, similarly to the first embodiment, is a period of time defined in advance as a period of time suitable for the user to view the page-turning video. The second time difference T2 is different from the first embodiment, and is an amount of change of 2×P(M/2) of the reproduction time to be described later.

The variable speed reproduction is a reproduction gradually increasing the reproduction speed when the page movement is started, and gradually reducing the reproduction speed when the reproduction time comes closer to the page time of the second page. When the control unit 6 controls the reproduction speed of the decode unit 3 as described above, it is possible to cause the user to view a beautiful page-turning video.

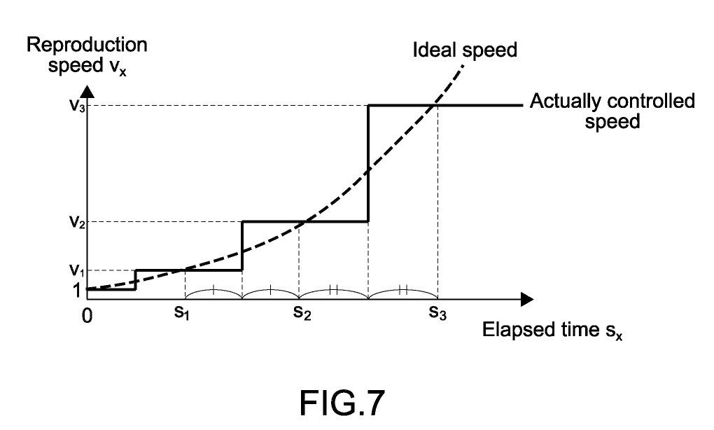

The variable speed reproduction will be specifically described. FIG. 7 is a conceptual view for describing the variable speed reproduction. In FIG. 7, there is shown an example in the case of reducing the reproduction speed in an exponential manner after the reproduction speed is increased in an exponential manner when the page movement is started. In the graph of FIG. 7, the vertical axis indicates a speed vx of the variable speed reproduction. Here, it is assumed that the speeds that the decode unit 3 can employ are denoted by v1, v2, and v3. The horizontal axis indicates an elapsed time sx, and the control unit 6 completes the page movement during the period of time M, and hence s3=M/2 is set. In FIG. 7, the elapsed time for increasing the reproduction speed is shown, and the elapsed time for reducing the reproduction speed is omitted.

When the ideal speed at the time of acceleration is expressed by v(s)=eαs, the elapsed time sx can be expressed by sx=(1/α)logvx. As shown in FIG. 7, the control unit 6 performs a control so that the speed is vx at a middle elapsed time between the elapsed time sx and the elapsed time sx−1. With this, the amount of change of P(M/2) of the reproduction time in an elapsed period of time of M/2 can be expressed by the following Equation (1).

$$P ( \frac{M}{2} ) = {v}_{n} ( \frac{M}{2} - {s}_{n} ) + {\sum }_{u = 1}^{n} \{ ( \frac{{v}_{u} + {v}_{u - 1}}{2} ) ( {s}_{u} - {s}_{u - 1} ) \} \qquad [ Equation 1 ]$$

In Equation (1), s0=0 and v0=1 are established.

The acceleration is terminated during the elapsed period of time M/2, and the same amount of change P can be obtained also in the following deceleration, and hence in the elapsed period of time M, an amount of change P(M) of the reproduction time becomes 2×P(M/2). Therefore, the control unit 6 calculates this 2×P(M/2), and in the case where the page time difference absolute value |d| is larger than 2×P(M/2), the jump becomes necessary in addition to the variable speed reproduction. Thus, in this embodiment, the second time difference T2 is 2×P(M/2).

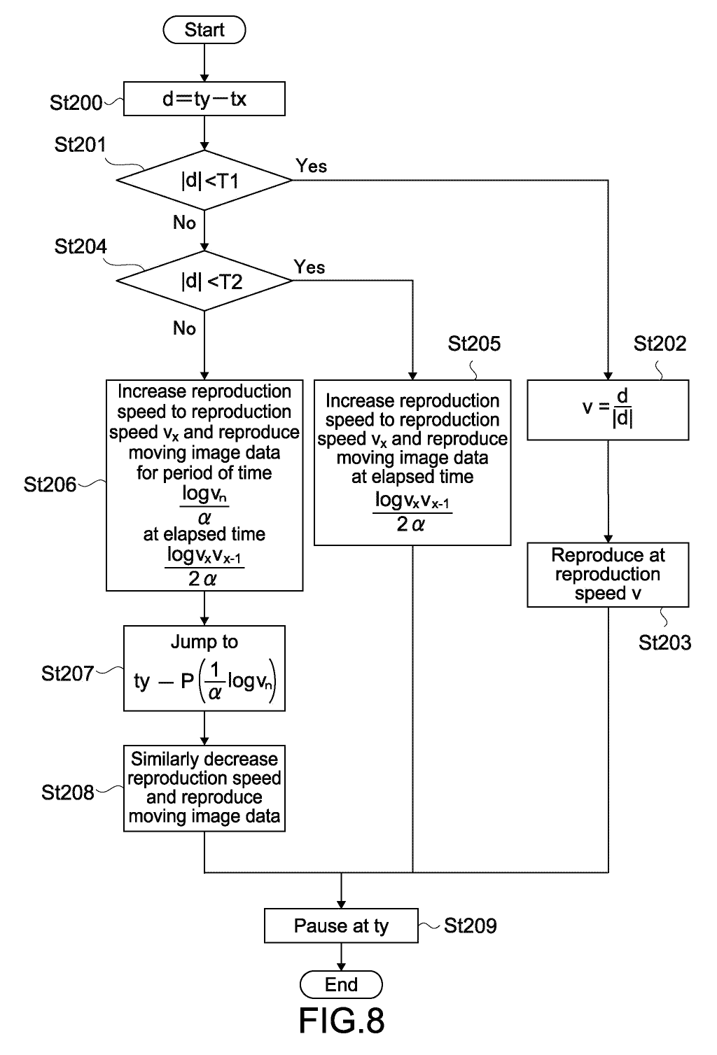

FIG. 8 is a flow chart of a control of the decode unit 3 by the control unit 6. As described above, the control unit 6 determines the page time difference d by subtracting the page time tx from the page time ty (St200). Next, the control unit 6 compares the page time difference absolute value |d| with the first time difference T1 (St201). In the case where the page time difference absolute value |d| is smaller than the first time difference T1 (Yes in St201), the reproduction speed v is expressed by d/|d|. That is, the normal speed reproduction is performed (St202). In this case, the control unit 6 controls the decode unit 3 to reproduce the reproduction speed v=d/|d| (St203). In the case where the page time difference absolute value |d| is larger than the first time difference T1 (No in St201), the control unit 6 compares the page time difference absolute value |d| with the second time difference T2 (St204).

Next, in St204, in the case where the page time difference absolute value |d| is smaller than the second time difference T2 (Yes in St204), the control unit 6 controls the decode unit 3 to increase the reproduction speed v at an elapsed time (logvxvx−1)/2α to the reproduction speed vx and to perform a reproduction. That is, the variable speed reproduction is performed (St205). The reduction of the speed is performed in the same way.

In the case where the page time difference absolute value |d| is larger than the second time difference T2 (No in St204), the control unit 6 controls the decode unit 3 to increase the reproduction speed v at the elapsed time (logvxvx−1)/2α to the reproduction speed vx, and to perform a reduction during a period of time (1/α)logvn (St206).

Next, the control unit 6 controls the decode unit 3 so that the reproduction time jumps to ty−P(1/α)logvn) being the page time of the destination page (St207). After that, the control unit 6 controls the decode unit 3 to perform a reproduction while similarly reducing the speed (St208). When the reproduction time arrives at the page time ty in the reproduction in St203, St205, or St208, the control unit 6 controls the decode unit 3 to pause the reproduction of the first moving image data D1 (St209). With this, the image of the destination page of the page time ty is displayed on the display.

As described above, the control unit 6 determines the reproduction speed depending on the page time difference between the source page and the destination page d, and hence even if the distance between the source page and the destination page is large, it is possible to complete the movement within a predetermined period of time while displaying an appropriate page-turning video. In addition, in this embodiment, in the case where the page time difference absolute value |d| is equal to or larger than the first time difference T1, the control unit 6 gradually increases and reduces the reproduction speed and performs a reproduction. Therefore, it is possible to cause the user to view a more realistic page-turning video.

### Third Embodiment

A third embodiment of the present invention will be described.

In the third embodiment, the same parts as those in the first embodiment will be denoted by the same symbols and the description thereof will be omitted.

The acquisition unit 2 according to this embodiment obtains the second moving image data D2 in addition to the first moving image data D1. The acquisition unit 2 is capable of obtaining the second moving image data D2 from the recording medium or the like which is identical to that of the first moving image data D1.

### [Structure of Second Moving Image Data]

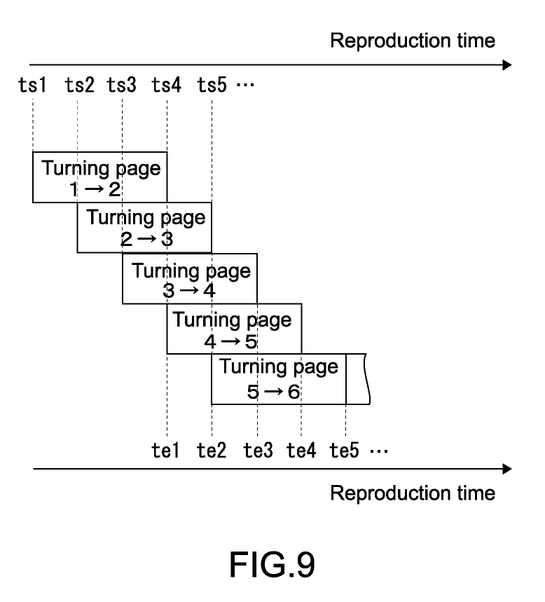

The second moving image data D2 will be described. FIG. 9 is a view showing the content of the moving image displayed at a reproduction time when the second moving image data D2 is reproduced. As shown in the drawing, regarding the second moving image data D2, during a time when the page turning of the page 1 is started and terminated, the page turning of the page 2 is started, and, subsequently, the page turning of the page 3 is started. A time on the moving image of the second moving image data D2 when the page turning of the page N is started is referred to as a page N turning start time tsN, and a time on the moving image when the page turning of the page N is terminated is referred to as a page N turning end time teN.

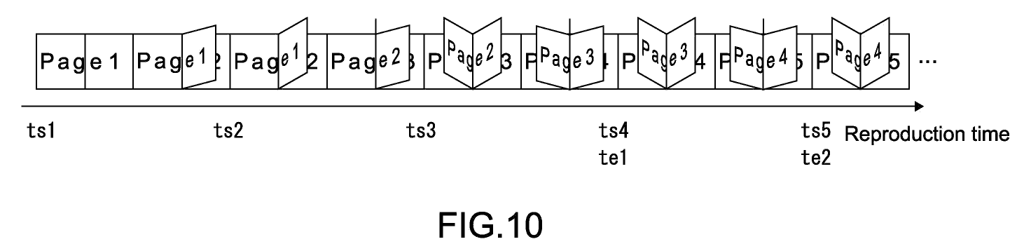

FIG. 10 is a schematic diagram showing a video, which is displayed when the second moving image data D2 is reproduced, as a frame. As shown in the drawing, before the reproduction time arrives at the page 1 turning end time te1, the page 2 turning is started at the page 2 turning start time ts2, and subsequently, at the page 3 turning start time ts3, the page 3 turning is started. It should be noted that although in this drawing, the page 1 turning end time te1 and the page turning start time ts4 are the same reproduction time, the present invention is not limited thereto. Further, the number of pages the page turning of which is started from the page turning start to the page turning end of one page is not limited to two. Although in FIG. 10, the page-turning video is expressed in a discontinuous way, in fact, more frames are used so that the video can be made continuous. The page-turning video is generated so that the video is prevented from looking unnatural even when the video is reversely reproduced.

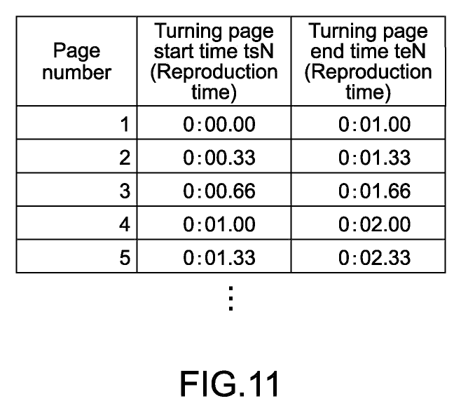

Further, the second moving image data D2 includes the page time table. FIG. 11 shows an example of the page time table. As shown in the drawing, the page time table is a table in which a page turning start time (tsN) and a page turning end time (teN) are registered for each of the pages.

### [Reproduction of Moving Image]

Next, the outline of the operation of the reproduction of the book content by the information processing apparatus of this embodiment will be described.

Schematically, when the page number to be next displayed is designated by the user through the input unit 4, the control unit 6 calculates the page time difference d as in the first embodiment. In the case where the page time difference absolute value |d| is smaller than the first time difference T1, the control unit 6 controls the decode unit 3 to perform the normal speed reproduction with respect to the first moving image data D1. Further, in the case where the page time difference absolute value |d| is larger than the first time difference T1 and smaller than the second time difference T2, the control unit 6 controls the decode unit 3 to perform the high speed reproduction with respect to the first moving image data D1.

In the case where the page time difference absolute value |d| is larger than the second time difference T2, the control unit 6 calculates a “page turning time difference e.” The page turning time difference e is calculated by subtracting the page turning end time of the source page from the page turning start time of the destination page in the second moving image data D2. In the case where the page turning time difference absolute value |e| is larger than a third time difference T3, the control unit 6 controls the decode unit 3 to perform the normal speed reproduction with respect to the second moving image data D2. In the case where the page turning time difference absolute value |e| is larger than a third time difference T3 and smaller than the fourth time difference T4, the control unit 6 controls the decode unit 3 to perform the high speed reproduction with respect to the second moving image data D2. In addition, in the case where the page turning time difference absolute value |e| is larger than the fourth time difference T4, the control unit 6 controls the decode unit 3 to reproduce the second moving image data D through combining the maximum speed reproduction with the jump.

The third time difference T3 can be a period of time of T−2J obtained by subtracting a period of time 2J twice as long as a period of time J necessary for switching between the first moving image data D1 and the second moving image data D from the period of time T defined in advance as one suitable for the user to view the page-turning video. In the case where the page turning time difference absolute value |e| is smaller than the third time difference T3, it is possible to move from the source page to the destination page within a period of time suitable for the movement even if the second moving image data D2 is reproduced at the normal speed.

In the case where the page turning time difference absolute value |e| is larger than the third time difference T3, when the reproduction speed of the second moving image data D2 is set as the normal speed reproduction, the movement from the source page to the destination page may not be achieved within a period of time suitable for the user to view the page-turning video, and hence the reproduction speed is set to be the high speed reproduction. The high speed reproduction means fast-forward or fast-rewind, and the reproduction speed of the high speed reproduction is set so that the time which it takes to move from the source page to the destination page becomes the closest to a period of time of T−2J.

The fourth time difference T4 is larger than the third time difference T3, is a time difference obtained by multiplexing a period of time of M−2J, which is obtained by subtracting a period of time 2J twice as long as a period of time J from the period of time M, by the maximum reproduction speed of the decode unit 3, and can be expressed by “N(M−2J).” The period of time for which the user can wait without feeling uncomfortable is arbitrarily set. That is, this fourth time difference T4 is a reproduction time on the moving image, which proceeds at a maximum amount during the period of time M, In the case where the page turning time difference absolute value |e| is larger than the fourth time difference T4, even if the decode unit 3 performs a reproduction at the maximum reproduction speed, the movement to the destination page may not be achieved within the period of time M. Therefore, the second moving image data D2 is reproduced through combining the maximum speed reproduction with the jump.

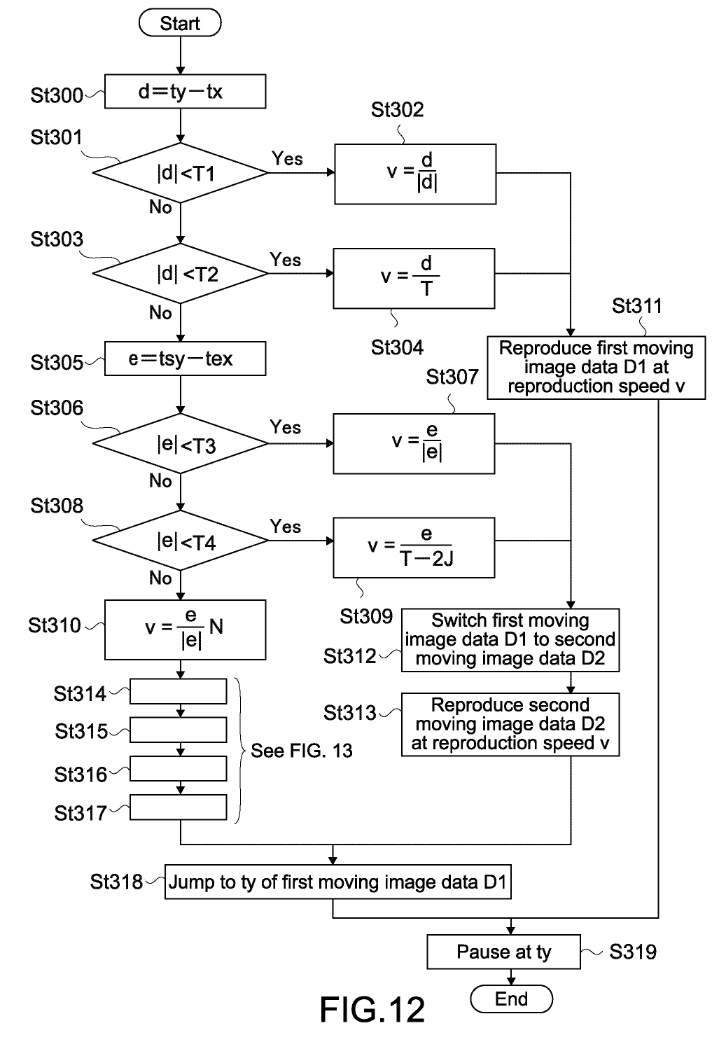

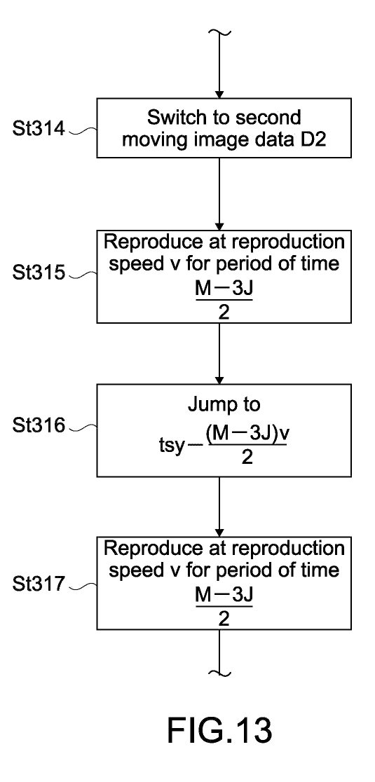

FIG. 12 and FIG. 13 are flowchart of the control of the decode unit 3 by the control unit 6. As described above, the control unit 6 determines the page time difference d by subtracting the page time tx from the page time ty (St300). Next, the control unit 6 compares the page time difference absolute value |d| with the first time difference T1 (St301). In the case where the page time difference absolute value |d| is smaller than the first time difference T1 (Yes in St301), the control unit 6 sets the reproduction speed v to d/|d|. That is, the normal speed reproduction is performed (St302). In the case where the page time difference absolute value |d| is larger than the first time difference T1 (No in St301), the control unit 6 compares the page time difference absolute value |d| with the second time difference T2 (St303).

Next, in the case where in St303, the page time difference absolute value |d| is smaller than the second time difference T2 (Yes in St303), the control unit 6 sets the reproduction speed v to d/T. That is, the high speed reproduction is performed (St304). The reproduction speed v is a reproduction speed to move by the page time difference d for an ideal period of the time in view of the movement during the period of time T defined in advance as one suitable for the user to view the page-turning video. Thus, the setting is performed so that as the difference between the page time tx and the page time ty becomes larger, the reproduction speed v becomes higher, and the movement can be completed within a period of time closer to that in the case of the first time difference T1 as much as possible. It should be noted that, in the case where d/T does not correspond to the reproduction speed that the decode unit 3 can employ, d/T (ideal value) is set as the reproduction speed.

In the case where the page time difference absolute value |d| is larger than the second time difference T2 (No in St303), the control unit 6 calculates a page turning time difference e by subtracting a page turning end time tex of the source page from the page turning start time tsy of the destination page in the second moving image data D2 (St305). Next, the control unit 6 compares the absolute value of the page turning time difference e (hereinafter, referred to as page turning time difference absolute value |e|) with the third time difference T3 (St306).

Next, in the case where in St306, the page turning time difference absolute value |e| is smaller than the third time difference T3 (Yes in St306), the control unit 6 sets the reproduction speed v to e/|e|. That is, the normal speed reproduction is performed (St307). In the case where the page turning time difference absolute value |e| is larger than the third time difference T3 (No in St306), the control unit 6 compares the page turning time difference absolute value |e| with the fourth time difference T4 (St308).

Next, in the case where in St308, the page turning time difference absolute value |e| is smaller than the fourth time difference T4 (Yes in St308), the control unit 6 sets the reproduction speed v to e/(T−2J). That is, the high speed reproduction is performed (st309). The reproduction speed v is a reproduction speed to move by the page turning time difference e for a period of time of T−2J. It should be noted that, in the case where e/(T−2J) does not correspond to the reproduction speed that the decode unit 3 can employ, e/(T−2J) (ideal value) is set as the reproduction speed. In the case where the page turning time difference absolute value |e| is larger than the fourth time difference T4 (No in St308), the control unit 6 sets the reproduction speed v to (e/|e|)·N. That is, the maximum speed reproduction is performed (St310).

Next, in the case of “Yes” in St301 or St303, the control unit 6 controls the decode unit 3 to reproduce the first moving image data D1 at the reproduction speed v determined in St302 or St304 (St311).

Further, in the case of “Yes” in St306 or St308, the control unit 6 controls the decode unit 3 to switch the moving image data to be reproduced from the first moving image data D1 to the second moving image data D2 (St312). As described above, this switching takes a period of time J. After that, the control unit 6 controls the decode unit 3 to reproduce the second moving image data D2 at the reproduction speed v determined in St307 or St309 (St313).

In addition, in the case of “No” in St308, the control unit 6 controls the decode unit 3 to switch the moving image data to be reproduced from the first moving image data D1 to the second moving image data D2 (St314). Next, the decode unit 3 is controlled to reproduce the second moving image data D2 at the reproduction speed v determined in St310 for a period of time of (M−3J)/2 (St315). The period of time 3J is the sum of the period of time 2J necessary for the first moving image data D1 and the second moving image data D2 and a period of time J necessary for a jump. In order to perform the reproduction at the maximum reproduction speed immediately after the start of the movement and immediately before the end of the movement, the control unit 6 control the decode unit 3 to perform the reproduction at the maximum reproduction speed for a half of a period of time of (M−3J).

Subsequently, the control unit 6 controls the decode unit 3 so that the reproduction time jumps to tsy−(M−3J)·v/2 (St316). The reproduction time tsy−(M−3J)·v/2 means such a reproduction time that a remained period of time up to the destination page turning start time tsy on the second moving image data D2 becomes (M−3J)·v/2 during which the maximum speed reproduction is performed immediately before the end of the movement. Subsequently, the control unit 6 controls the decode unit 3 to perform a reproduction from the reproduction time tsy−(M−3J)·v/2 at the reproduction speed v again for a period of time of (M−3J)/2 (St317).

Subsequently, when the reproduction time of the decode unit 3 arrives at the page turning start time tsy of the destination page in St317, the control unit 6 controls the decode unit 3 to jump the reproduction time to the page time ty of the first moving image data D1 (St318).

When the reproduction time arrives at the page time ty in St311 or St318, the control unit 6 controls the decode unit 3 to pause the reproduction of the first moving image data D1 (St319). With this, the image of the destination page at the page time ty is displayed on the display.

As described above, the information processing apparatus according to this embodiment is capable of reproducing the second moving image data being the moving image data of the video in which the pages are turned at high speed even in the case where the difference between the destination page designated by the user and the source page is large, to thereby cause the user to view the video in which the pages are turned at high speed.

### Fourth Embodiment

A fourth embodiment of present invention will be described.

In the fourth embodiment, the same parts as those in the first embodiment will be denoted by the same symbols and the description thereof will be omitted.

It is assumed that the decode unit 3 according to this embodiment is capable of reproducing the moving image data only in a forward direction (hereinafter, referred to as forward reproduction), and that the decode unit 3 according to this embodiment is incapable of reproducing the moving image data in a reverse direction (hereinafter, referred to as reverse reproduction). The acquisition unit 2 according to this embodiment obtains the third moving image data D3 in addition to the first moving image data D1. The acquisition unit 2 is capable of obtaining the third moving image data D3 from the recording medium or the like, which is identical to that of the first moving image data D1.

### [Structure of Third Moving Image Data]

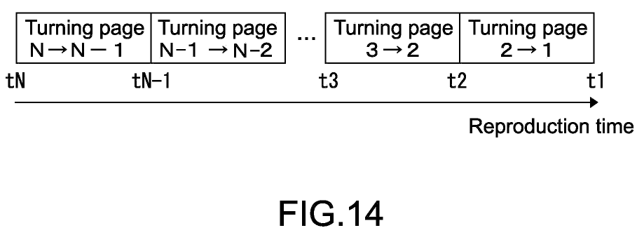

The third moving image data D3 will be described. FIG. 14 is a view showing the content of the moving image displayed at a reproduction time when the third moving image data D3 is reproduced. As shown in the drawing, in the third moving image data D3, from the page N being the last page to the page 1, the pages are turned one by one in reverse order of the page numbers. In the third moving image data D3, a time on the moving image when the page turning of the page N is started is referred to as a page time tN.

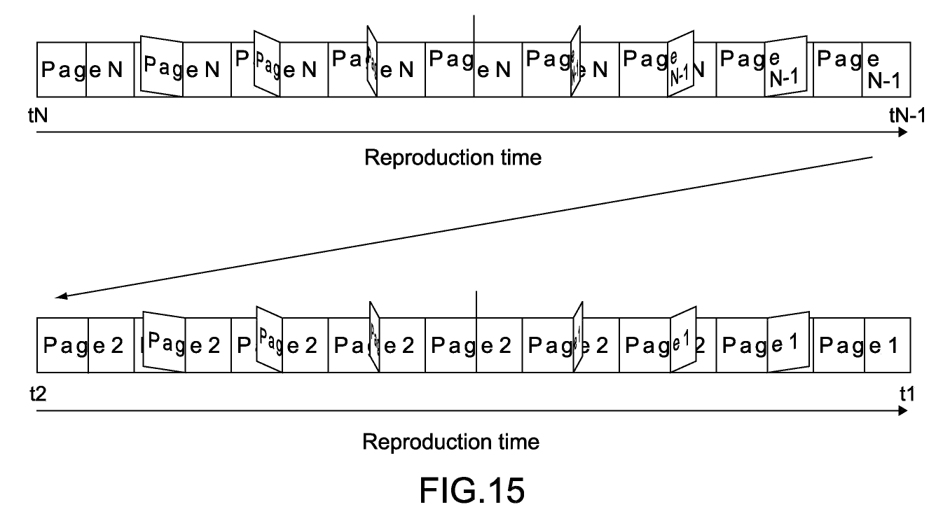

FIG. 15 is a schematic diagram showing a video, which is displayed when the third moving image data D3 is reproduced, as a frame. As shown in the drawing, between the page time tN and the page time tN−1, the page-turning video from the page N to the page N−1 is reproduced. After that, similarly, between the page time t2 and the page time t1, the page-turning video of turning pages from the page 2 to the page 1 is reproduced. Although in FIG. 15, the page-turning video is expressed in a discontinuous way, in fact, more frames are used so that the video can be made continuous.

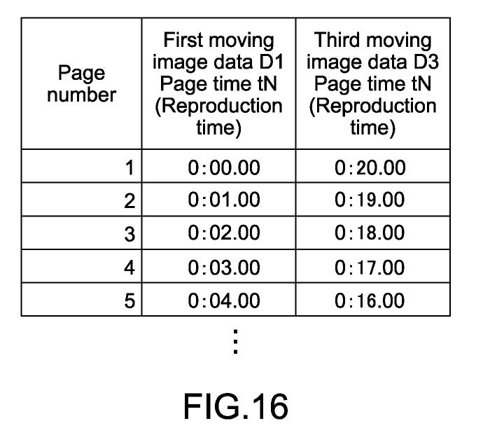

Further, the third moving image data D3 includes the page time table. FIG. 16 shows an example of the page time table. As shown in the drawing, the page time table is a table in which the page time (tN) on the first moving image data D1 and the page time (tN) on the third moving image data D3 are registered for each of the pages.

### [Reproduction of Moving Image]

Next, the outline of the operation of the reproduction of the book content by the information processing apparatus of this embodiment will be described.

Schematically, the control unit 6 controls the decode unit 3 to reproduce the first moving image data D1 in order to reproduce the book content in the forward direction. On the other hand, the control unit 6 controls the decode unit to reproduce the third moving image data D3 in order to reproduce the book content in the reverse direction. At this time, when the page number of the page to be next displayed is designated by the user through the input unit 4, the control unit 6 calculates the page time difference d by subtracting a page time tx of a source page from a page time ty of a destination page and determining the absolute value thereof. Next, in the case where ty>tx is established when the control unit 6 controls the decode unit 3 to reproduce the first moving image data D1, or in the case where ty<tx is established when the control unit 6 controls the decode unit 3 to reproduce the third moving image data D3, the control unit 6 controls the decode unit 3 not to switch the moving image data to be reproduced. On the other hand, in the case where ty<tx is established when the control unit 6 controls the decode unit 3 to reproduce the third moving image data D1, or in the case where ty>tx is established when the control unit 6 controls the decode unit 3 to reproduce the third moving image data D3, the control unit 6 controls the decode unit 3 to switch the moving image data to be reproduced. In addition, in the case where the control unit 6 controls the decode unit 3 not to switch the moving image data to be reproduced, the control unit 6 compares, as described above, the page time difference d with the first time difference T1 and the second time difference T2, to thereby determine the reproduction speed. Further, in the case where the control unit 6 controls the decode unit 3 to switch the moving image data to be reproduced, the control unit 6 compares the page time difference d with a fifth time difference T5 and a sixth time difference T6, to thereby determine the reproduction speed.

The fifth time difference T5 can be a period of time of T−J obtained by subtracting a period of time necessary for switching between the first moving image data D1 and the third moving image data D3 from the period of time T defined in advance as one suitable for the user to view the page-turning video. In the case where the page time difference d is smaller than the fifth time difference T5, the movement from the source page to the destination page within a period of time suitable which it takes to move can be achieved even if the first moving image data D1 or the third moving image data D3 is reproduced at the normal speed.

In the case where the page time difference d is larger than the fifth time difference T5, the movement from the source page to the destination page within a period of time suitable for the user to view the page-turning video may not be achieved when the first moving image data D1 or the third moving image data D3 is reproduced at normal speed, and hence the reproduction speed is set to be the high speed reproduction. The high speed reproduction means fast-forward in the case where the decode unit 3 reproduces the first moving image data D1 or means fast-rewind in the case where the decode unit 3 reproduces the third moving image data D3. The reproduction speed means a speed at which the time which it takes to move from the source page to the destination page becomes the closest to that in the case of the fifth time difference T5.

The sixth time difference T6 is larger than the fifth time difference T5, is a time difference obtained by multiplying the period of time M-J, which is obtained by subtracting the period of time J from the period of time M, by the maximum reproduction speed of the decode unit 3, and is expressed as “N(M−J).” That is, the sixth time difference T6 is a reproduction time on the moving image, which proceeds at a maximum amount during the period of time M. In the case where the page time difference d is larger than the sixth time difference T6, the movement to the destination page within the period of time M may not be achieved even if the decode unit 3 performs a reproduction at the maximum reproduction speed, and hence a reproduction is performed through combining the maximum speed reproduction and the jump.

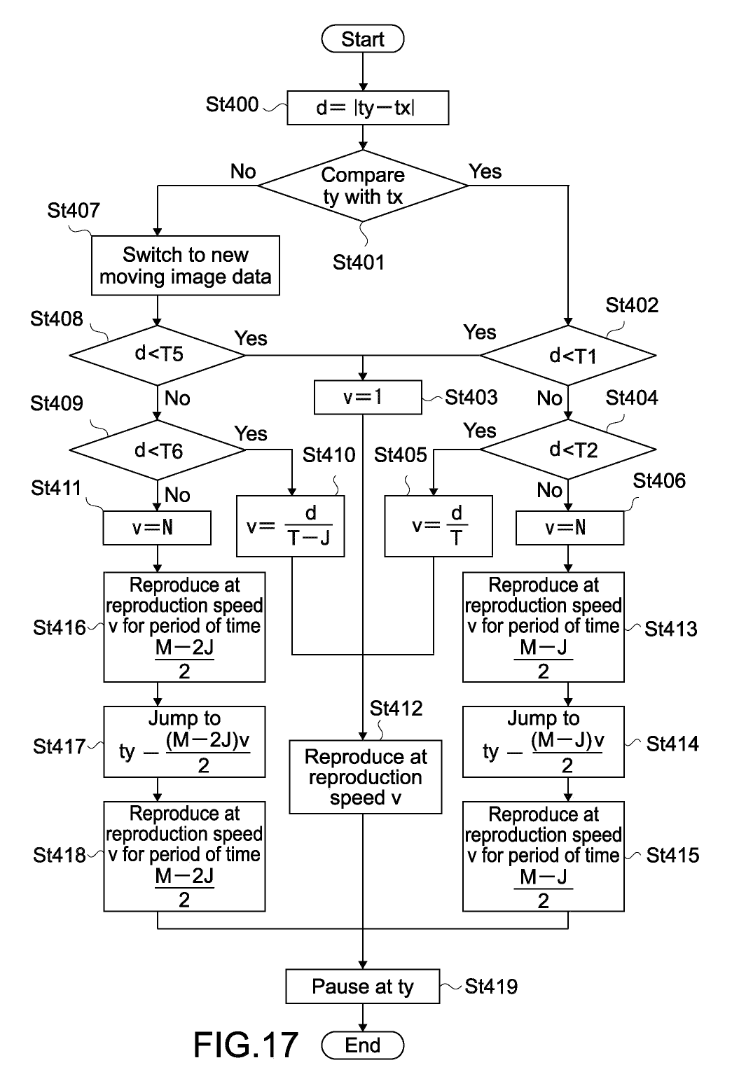

FIG. 17 is a flow chart of a control of the decode unit 3 by the control unit 6. As described above, the control unit 6 calculates the page time difference d by subtracting the page time tx from the page time ty and determining the absolute value thereof (St400). Next, the control unit 6 compares the page time ty with the page time tx (St401). In the case where ty>tx is established when the control unit 6 controls the decode unit 3 to reproduce the first moving image data D1, or in the case where ty<tx is established when the control unit 6 controls the decode unit 3 to reproduce the third moving image data D3 (Yes in St401), the control unit 6 controls the decode unit 3 not to switch the moving image data being reproduced, and controls the decode unit 3 to reproduce the moving image data as it is. On the other hand, in the case where ty<tx is established when the control unit 6 controls the decode unit 3 to reproduce the first moving image data D1, or in the case where ty>tx is established when the control unit 6 controls the decode unit 3 to reproduce the third moving image data D3 (No in St401), the control unit 6 controls the decode unit 3 to switch the moving image data being reproduced.

In the case where the control unit 6 controls the decode unit 3 not to switch the moving image data to be reproduced (Yes in St401), the same operation as in the first embodiment is performed. That is, the control unit 6 compares the page time difference d with the first time difference T1 (St402). In the case where the page time difference d is smaller than the first time difference T1 (Yes in St402), the control unit 6 sets the reproduction speed v to 1 (normal speed reproduction) (St403). In the case where the page time difference d is larger than the first time difference T1 (No in St402), the control unit 6 compares the page time difference d with the second time difference T2 (St404).

Next, in the case where in St404, the page time difference d is smaller than the second time difference T2 (Yes in St404), the control unit 6 sets the reproduction speed v to d/T. That is, the high speed reproduction is performed (St405). It should be noted that in the case where d/T does not correspond to the reproduction speed that the decode unit can employ, d/T (ideal value) is set as the reproduction speed.

In the case where the page time difference d is larger than the second time difference T2 (No in St404), the control unit 6 sets the reproduction speed v to N. That is, the maximum speed reproduction is performed (St406). The N is the maximum reproduction speed of the decode unit 3 as described above. As described above, in the case where the control unit 6 controls the decode unit 3 not to switch the moving image data to be reproduced, the control unit 6 compares the page time difference d with the first time difference T1 and the second time difference T2, to thereby determine the reproduction speed.

In the case where the control unit 6 controls the decode unit 3 to switch the moving image data to be reproduced (No in St401), the following operation is performed. Specifically, the control unit 6 controls the decode unit 3 to switch the moving image data to be reproduced (St407). Specifically, when the control unit 6 controls the decode unit to reproduce the first moving image data D1, the control unit 6 controls the decode unit 3 to switch the first moving image data D1 to the third moving image data D3. On the other hand, when the control unit 6 controls the decode unit 3 to reproduce the third moving image data D3, the control unit 6 controls the decode unit 3 to switch the third moving image data D3 to the first moving image data D1. It is assumed that the above-mentioned switching takes the period of time J. Next, the control unit 6 compares the page time difference d with the fifth time difference T5 (St408). In the case where the page time difference d is smaller than the fifth time difference T5 (Yes in St408), the control unit 6 sets the reproduction speed v to 1. That is, the normal speed reproduction is performed (St403). In the case where the page time difference d is larger than the fifth time difference T5 (No in St408), the control unit 6 compares the page time difference d with the sixth time difference T6 (St409).

Next, in the case where in St409, the page time difference d is smaller than the sixth time difference T6 (Yes in St409), the control unit 6 sets the reproduction speed v to d/(T−J). That is, the high speed reproduction is performed (St410). It should be noted that, in the case where d/(T−J) does not correspond to the reproduction speed that the decode unit 3 can employ, d/(T−J) (ideal value) is set as the reproduction speed.

In the case where the page time difference d is larger than the sixth time difference T6 (No in St409), the control unit 6 sets the reproduction speed v to N (maximum speed reproduction) (St411). The N is the maximum reproduction speed of the decode unit 3 as described above. As described above, in the case where the control unit 6 controls the decode unit 3 to switch the moving image data to be reproduced, the control unit 6 compares the page time difference d with the fifth time difference T5 and the sixth time difference T6, to thereby determine the reproduction speed.

Next, in the case of “Yes” in St402 or St404, the control unit 6 controls the decode unit 3 to reproduce the first moving image data D1 or the third moving image data D3 at the reproduction speed v determined in St403 or St405 (St412). Alternatively, in the case of “Yes” in St408 or St409, the control unit 6 controls the decode unit 3 to reproduce the third moving image data D3 at the reproduction speed v determined in St403 or St410 (St412).

Further, in the case of “No” in St404, the control unit 6 controls the decode unit 3 to reproduce the first moving image data D1 or the third moving image data D3 at the reproduction speed v determined in St406 for (M−J)/2 (St413). In order to perform the reproduction at the maximum reproduction speed immediately after the start of the movement and immediately before the end of the movement, the control unit 6 controls the decode unit 3 to perform a reproduction for a period of time of a half of the period of time of M−J at the maximum reproduction speed.

Subsequently, the control unit 6 controls the decode unit 3 so that the reproduction time jumps to ty−(M−J)·v/2 (St414). The ty−(M−J)·v/2 being the reproduction time means such a reproduction time that a remained period of time up to the page time ty becomes (M−J)·v/2 during which the maximum speed reproduction is performed immediately before the end of the movement. Subsequently, the control unit 6 controls the decode unit 3 to perform a reproduction from ty−(M−J)·v/2 being the reproduction time at the reproduction speed v again for (M−J)/2 (St415).

Further, in the case of “No” in St409, the control unit 6 controls the decode unit 3 to reproduce the first moving image data D1 at the reproduction speed v determined in St411 for a period of time of (M−2J)/2 (St416). The M is a period of time defined in advance as a period of time which the user can wait as described above, and the J is a period of time necessary for a jump. In order to perform the reproduction at the maximum reproduction speed immediately before the start of the movement and immediately after the end of the movement, the control unit 6 controls the decode unit 3 to perform a reproduction for a period of time of a half of the period of time of M−2J at the maximum reproduction speed.

Subsequently, the control unit 6 controls the decode unit 3 so that the reproduction time jumps to ty−(M−2J)·v/2 (St417). The ty−(M−2J)·v/2 being the reproduction time means such a reproduction time that a remained period of time up to the page time ty becomes (M−2J)·v/2 during which the maximum speed reproduction is performed immediately before the end of the movement. Subsequently, the control unit 6 controls the decode unit 3 to perform a reproduction from ty−(M−2J)·v/2 being the reproduction time at the reproduction speed v again for (M−2J)/2 (St418).

When the reproduction time arrives at the page time ty in St412, St415, or St418, the control unit 6 controls the decode unit 3 to pause the reproduction of the first moving image data D1 or the third moving image data D3 (St419). With this, the image of the destination page at the page time ty is displayed on the display.

As described above, even in a case of a device incapable of performing a reverse reproduction, the information processing apparatus according to this embodiment is capable of reproducing the third moving image data D3 being the moving image data of the video in which the pages are turned in the reverse direction, to thereby cause the user to view the page-turning video during the movement from the source page to the destination page having the page number smaller than that of the source page.

The present invention is not limited only to the above-mentioned embodiments, and can be modified without departing from the gist of the present invention.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
an acquisition unit configured to obtain, of moving image data including images of a plurality of pages having serial page numbers and an image of motion of turning the plurality of pages one by one in order of the page numbers, first moving image data in which a page time being a time on the moving image data is assigned to each of the plurality of pages;
a reproduction unit configured to reproduce the first moving image data obtained by the acquisition unit, to generate a moving image, and to display the moving image on a display screen;
an input unit configured to receive, from a user, a designation of a second page different from a first page, the first page being a page of the first moving image data currently displayed on the display screen; and
a control unit configured to calculate a page time difference being a difference between a page time of the first page and a page time of the second page, and to control a reproduction speed of the first moving image data depending on the page time difference.

2. The information processing apparatus according to claim 1, wherein
the control unit selects a first reproduction speed being a normal speed in a case where the page time difference is smaller than a predetermined first time difference, and
the control unit selects a reproduction speed at which a period of time for reproducing the moving image corresponding to the page time difference is the closest to the first time difference in a case where the page time difference is equal to or larger than the first time difference.

3. The information processing apparatus according to claim 2, wherein
the control unit jumps the reproduction time of the first moving image data in a case where the page time difference is equal to or larger than a second time difference, the second time difference being set in advance within a range larger than the first time difference.

4. The information processing apparatus according to claim 2, wherein
the control unit varies the second reproduction speed depending on the reproduction time.

5. The information processing apparatus according to claim 2, wherein
the acquisition unit further obtains second moving image data constituted of an image of motion of turning the plurality of pages one by one in order of the page numbers, and
the control unit causes the reproduction unit to reproduce the second moving image data in a case where the page time difference is equal to or larger than a second time difference, the second time difference being set in advance within a range larger than the first time difference.

6. The information processing apparatus according to claim 2, wherein
the acquisition unit further obtains third moving image data including a motion of turning the plurality of pages one by one in reverse order of the page numbers, and
the control unit causes the reproduction unit to reproduce the third moving image data in a case where the page number of the second page is smaller than the page number of the first page.

7. An information processing method, comprising:
obtaining, by an acquisition unit, of moving image data including images of a plurality of pages having serial page numbers and an image of motion of turning the plurality of pages one by one in order of the page numbers, first moving image data in which a page time being a time on the moving image data is assigned to each of the plurality of pages;
reproducing, by a reproduction unit, the first moving image data obtained by the acquisition unit, generating a moving image, and displaying the moving image on a display screen;
receiving, by an input unit, from a user, a designation of a second page different from a first page, the first page being a page of the first moving image data currently displayed on the display screen; and
calculating, by a control unit, a page time difference being a difference between a page time of the first page and a page time of the second page, and controlling the reproduction speed of the first moving image data depending on the page time difference.

8. A program to cause a computer to function as:
an acquisition unit configured to obtain, of moving image data including images of a plurality of pages having serial page numbers and an image of motion of turning the plurality of pages one by one in order of the page numbers, first moving image data in which a page time being a time on the moving image data is assigned to each of the plurality of pages;
a reproduction unit configured to reproduce the first moving image data obtained by the acquisition unit, to generate a moving image, and to display the moving image on a display screen;
an input unit configured to receive, from a user, a designation of a second page different from a first page, the first page being a page of the first moving image data currently displayed on the display screen; and
a control unit configured to calculate a page time difference being a difference between a page time of the first page and a page time of the second page, and to control the reproduction speed of the first moving image data depending on the page time difference.
